(19) United States
(12) Patent Application Publication
(10) Pub. No.: US 2019/0073734 A1
(43) Pub. Date: Mar. 7, 2019

(54) SYSTEMS AND METHODS FOR IDENTIFYING SAFETY AND SECURITY THREATS IN SOCIAL MEDIA CONTENT

(71) Applicant: Social Sentinel, Inc., Burlington, MT (US)

(72) Inventors: Andrew J. Reischer, Burlington, VT (US); John Orrange, Burlington, VT (US); Scott Brightwell, Burlington, VT (US); Lexi Riemer, Burlington, VT (US); Natasha Conahan, Burlington, VT (US)

(73) Assignees: Social Sentinel, Inc., Burlington, VT (US); Social Sentinel, Inc., Burlington, VT (US)

(21) Appl. No.: 16/079,023

(22) PCT Filed: Feb. 23, 2017
(86) PCT No.: PCT/US2017/019143

§ 371 Date: Aug. 22, 2018

Related U.S. Application Data
(60) Provisional application No. 62/298,753, filed on Feb. 23, 2016.

(51) Int. Cl. G06Q 50/26; G06F 17/30; G06Q 50/00

(52) U.S. Cl. CPC G06Q 50/265; G06Q 50/01; G06F 17/30312; G06F 17/30867

(57) ABSTRACT

Exemplary embodiments are provided for a threat alert system for identifying safety and security concerns from social media content. The threat alert system receives a search term and combines it with another term from a library. Social media content is searched for the search term and the library term to identify content that includes safety and security concerns based on the search term and the library term. The library term aids in constraining the search of social media to identify content that includes safety and security concerns, rather than other benign information. Determination of an existence of a relationship between an author of the identified social media content results and an enterprise triggers generation and transmission of an alert to a device associated with the enterprise, the alert including the social media content results. Some embodiments opportunistically pattern match content in social media posts against a library of terms identify safety and security threats.

### CROSS-REFERENCE TO RELATED APPLICATION

The present application is related to and claims the benefit of priority of U.S. Provisional Patent Application No. 62/298,753, filed Feb. 23, 2016, the entire disclosure of which is incorporated herein by reference.

### BACKGROUND

Social media has become a widely accepted venue for communication in our society. Social media and social network applications have become popular for sharing content—such as image content, audio content, textual content, and location content—through the Internet. A user of a social network application can create and share content via a social network application using, for example, posts, messages, comments, blogs, and mobile device settings. Users share their life stories, their triumphs, their woes and failures; they document their everyday life. Additionally, users also may share real actionable safety and security threats (e.g., harm to selves, and harm to others). Social media content can be assessed to identify safety and security threats.

However, the public in general and, more specifically, social media application providers, do not want the “life story” of social media users, which is made public via social media content by the users themselves, used against them. Thus, there is a need to identify threats while ignoring the benign lifestory of a user. Some conventional systems allow an operator interested in detecting safety and security threats to monitor any social media content of a user, which is fraught with the potential to misuse a user's lifestory and is dependent on the operator of the monitoring system to ignore the benign lifestory. This can be unacceptable to both the general public and the social media application providers.

### SUMMARY

An example embodiment provides a method for identifying safety and security concerns from social media content. The method includes storing a library of terms in a database, where the library of terms represents terms to constrain searching of social media content to safety and security concerns. The method also includes receiving one or more search terms and combining the one or more search terms with one or more terms from the library stored in the database. Using a processor, social media content is searched based on the combination of the one or more search terms and the one or more terms from the library. The method includes identifying social media content results that include safety and security concerns based on the combined one or more search terms and the one or more terms from the library. The method also includes determining an existence of a relationship between an author of the identified social media content results and an enterprise, and generating and transmitting an alert to a device associated with the enterprise, where the alert includes at least the social media content results.

In some embodiments, the method includes generating a database of search terms based on keywords received as user input. In some embodiments, the one or more search terms are retrieved from the database of search terms.

In some embodiments, searching social media content based on the combination of the one or more search terms and the one or more terms from the library includes searching based on a grammatical relationship between the one or more search terms and the one or more terms from the library in the social media content.

In some embodiments, combining the one or more search terms with the one or more terms in the library includes specifying an order for the one or more search terms relative to the one or more terms in the library in the social media content.

In some embodiments, the one or more search terms are received via a user interface from a user, and in response to receiving the one or more search terms from the user, the method initiates the search of the social media content based on the combination of the one or more search terms and the one or more terms from the library.

In some embodiments, the one or more search terms is stored in the database, and the social media content is searched periodically for the combination of the stored search terms and the one or more terms from the library.

In some embodiments, the library includes a list of nouns, verbs, and phrases and relationships between them.

In some embodiments, the terms in the library are organized into topics, and each topic includes an algorithm used to combine the one or more search terms with the one or more terms from the library under the respective topic. In some embodiments, the method includes receiving a selection of one or more topics from the library.

In some embodiments, the existence of a relationship between an author of the identified social media content results and the enterprise is determined by querying a database storing a pre-determined description of a relationship between an author and an enterprise.

In some embodiments, the existence of the relationship is determined from one of location information, the author's use of a name of the enterprise, the author's use of a name of a person associated with the enterprise, and the author's connection with a person associated with the enterprise.

In some embodiments, the one or more search terms relate to or describe an enterprise of interest.

In some embodiments, the method also includes generating a database identifying relationships between one or more victims and one or more tormentors based on analysis of the social media content results generated by the one or more tormentors. In some embodiments, the method includes generating the alert based on the social media content results including social media content generated by the one or more victims. In a further embodiment, the method also includes transmitting the alert to the enterprise identified as having an relationship with the one or more victims.

Another example embodiment provides a system for identifying safety and security concerns from social media content. The system includes a processor and a memory in communication with the processor and storing instructions that cause the processor to store a library of terms in a database, where the library of terms represent terms to constrain identification of social media content to safety and security concerns, and receive one or more search terms. The processor is further caused to combine the one or more search terms with one or more terms from the library stored in the database, and search social media content based on the combination of the one or more search terms and the one or more terms from the library. The processor is caused to identify social media content results that include safety and security concerns based on the combination of the one or more search terms and the one or more terms from the library and determine an existence of a relationship between an author of the identified social media content results and an enterprise. The processor is further caused to generate and transmit an alert to a device associated with the enterprise, the alert including at least the social media content results.

Another example embodiment provides a non-transitory computer-readable storage medium storing code representing instructions that when executed are configured to cause a processor to perform a method. The method includes storing a library of terms in a database, where the library of terms represents terms to constrain searching of social media content to safety and security concerns. The method also includes receiving one or more search terms and combining the one or more search terms with one or more terms from the library stored in the database. Using a processor, social media content is searched based on the combination of the one or more search terms and the one or more terms from the library. The method includes identifying social media content results that include safety and security concerns based on the search term and the one or more terms from the library. The method also includes determining an existence of a relationship between an author of the identified social media content results and an enterprise, and generating and transmitting an alert to a device associated with the enterprise, where the alert includes at least the social media content results.

### BRIEF DESCRIPTION OF DRAWINGS

Some embodiments are illustrated by way of example in the accompanying drawings and should not be considered as a limitation of the invention:

FIG. 1 is a block diagram showing a threat alert system implemented in modules, according to an example embodiment;

FIG. 2 is a flowchart showing an example method for identifying relationships from social network content to mitigate enterprise safety and security concerns, according to an example embodiment;

FIG. 3 is a flowchart showing an example method for identifying safety and security concerns from social media content, according to an example embodiment;

FIG. 4 illustrates a network diagram depicting a system for implementing embodiments of a threat alert system; and

FIG. 5 is a block diagram of an example computing device that may be used to implement exemplary embodiments of a threat alert system described herein.

### DESCRIPTION OF EXEMPLARY EMBODIMENTS

Described herein are systems, methods, and non-transitory computer readable medium for a threat alert system to identify safety and security concerns from social media content. Embodiments of the present invention enable constrained searching of social media content to identify content that includes safety and security concerns, rather than a social media user's benign lifestory or comments. Embodiments of the threat alert system include the use of a library of terms to constrain searching of social media content to safety and security concerns.

The inventors of the present application recognized that searching social media content places too much burden, in both time and decision making, on enterprises. The inventors also recognized a need for safety and security threat detection in public social media content in a manner that honors user's privacy and is consistent with social network application providers' policies and concerns. Moreover, the inventors recognize that unconstrained searching of content available via social network applications may produce a user's benign lifestory and comments in the search results.

The embodiments described herein provide a threat alert system that identifies safety and security threats from social media content, while ignoring a user's benign lifestory. In some embodiments the threat alert system automatically runs searches (for example, system generated searches). In some embodiments, the system also, or alternatively, runs user-defined or user-initiated searches. Embodiments provide a library of terms, which can be stored in a database, that relate to security threats and safety threats. In some embodiments, the library terms also include terms that relate to benign lifestory, so those terms can be used to exclude social media content results that include benign lifestory. The system ensures that the search terms are combined with the terms from the library to constrain the search of social media content to identify only safety and security threats.

The threat alert system described herein limits unconstrained searches. Unconstrained searches are fraught with misuse, target benign lifestories of users, can overwhelm the operator of an assessment system with a sea of false positives, and consume vast amounts of data. The threat alert system described herein combines operator entered search terms with the terms in the library to identify results that are potential safety and security threats, while reducing or minimizing results that are not related to potential safety and security threats. As used herein, constrained searching refers to incorporating one or more terms from the library so that search results identified from searching social media content do not relate to an author's benign lifestory.

As used herein the phrase “search term” refers to information provided by a user and may include multiple terms, multiple phrases and/or a listing of terms and phrases.

As a non-limiting example, an operator may search for the term where the term is the name of the current U.S. President or other famous person, about whom there are hundreds of thousands of posts each day. The threat alert system described herein combines the search term, for example “Tom Brady,” with a list of threatening terms stored in the library such as “kill,” “shoot,” or “bomb.” The threat alert system ignores the social media content consisting of posts like “Tom Brady is a great athlete,” or “Tom Brady is a bozo,” but identifies social media content consisting of posts such as “I am going to kill Tom Brady.”

The threat alert system provides a library of terms, which may include phrases, and algorithms to associate the library terms to social media content to identify safety and security concerns. In some embodiments, the library of terms also include algorithms for associating the terms to social media content. The threat alert system enables a user to provide information related to assets of interest or definition of protected assets, where assets may be a location, a building, a person, or an organization. In some embodiments, the threat alert system also enables a user to define search terms such as keywords, phrases, or hashtags, to search social media content in a constrained fashion as described herein.

As used herein, “enterprise” can refer to an organization, an entity, a business, an operation, an establishment, and the like. Enterprise as used herein may also refer to a person or persons associated with an enterprise.

As used herein, “social network application” can refer to a social networking service, a social networking platform, a social networking website, a social media application, a social media service, a social media platform, a social media website, and the like.

As used herein, “content” or “social media content” can refer to any user-generated content or user-published content on a social network or media application, or any content made available on a social network or media application via text, audio, or video mediums. A social network or media application may refer to content as posts, blogs, comments, status updates, notifications, check-ins, Tweets™, likes, reviews, and others. Sometimes the content may be associated with a hashtag. A user that generates or publishes social media content may be referred to as the “author” of the content that he or she generates.

The following description is presented to enable any person skilled in the art to create and use a computer system configuration and related method and article of manufacture to identify safety and security concerns from social media or network content. Various modifications to the example embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention may be practiced without the use of these specific details. In other instances, well-known structures and processes are shown in block diagram form in order not to obscure the description of the invention with unnecessary detail. Thus, the present disclosure is not intended to be limited to the embodiments shown, but is to be accorded the widest scope consistent with the principles and features disclosed herein.

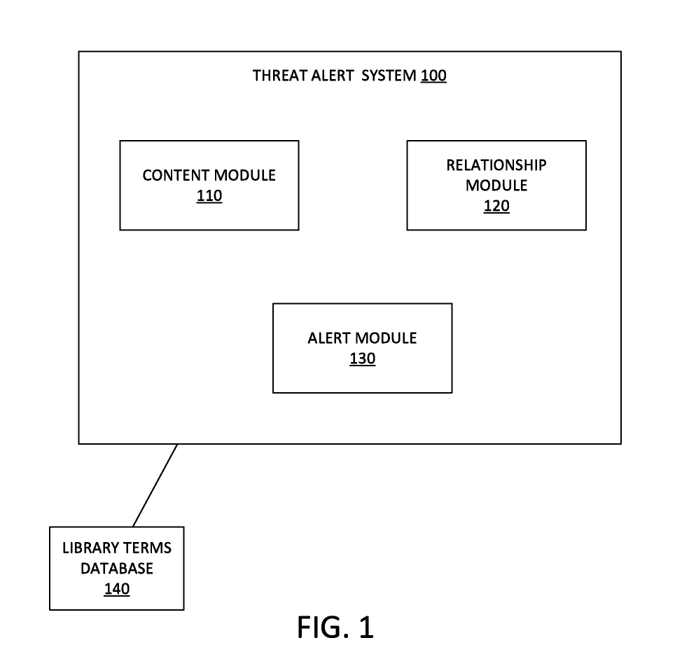

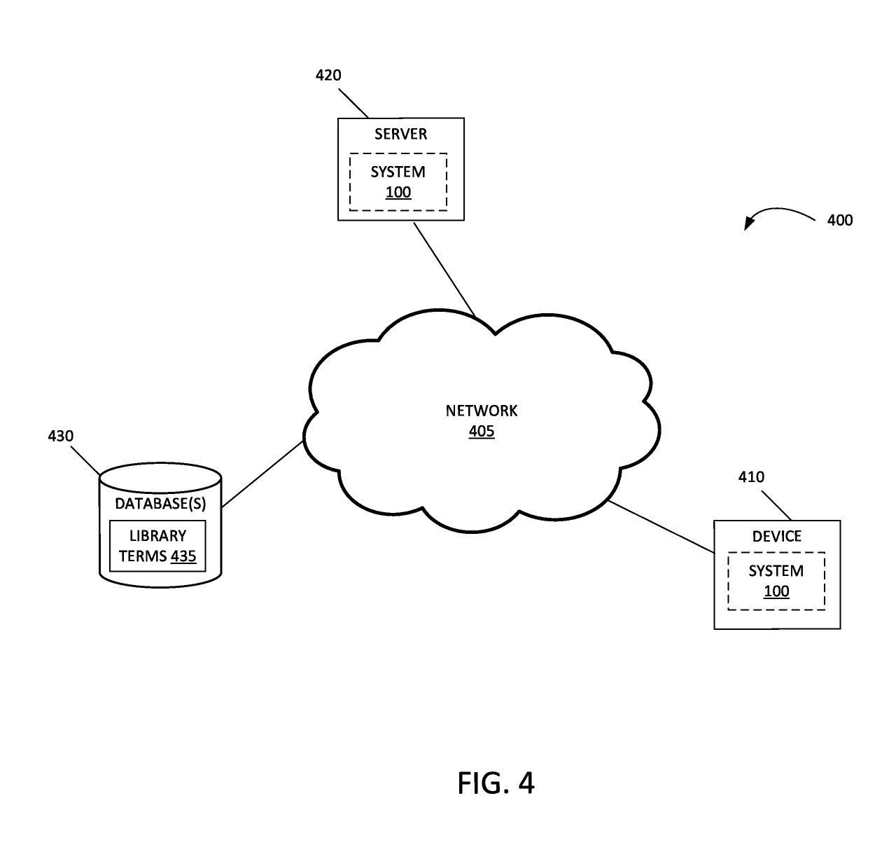

FIG. 1 is a block diagram showing example modules 110, 120, 130 that can be included in a threat alert system 100, according to an example embodiment. The threat alert system 100 is in communication with a library terms database 140. The modules may be implemented using a device and/or a system, such as, but not limited to, device 410 or server 420 described below in relation to FIG. 4. The modules may include various circuits, circuitry and one or more software components, programs, applications, apps or other units of code base or instructions configured to be executed by one or more processors included in device 410 or server 420. In other embodiments, one or more of modules 110, 120, 130 may be included in server 420, while others of the modules 110, 120, 130 can be provided in device 410. Although modules 110, 120, 130 are shown as distinct modules in FIG. 1, it should be understood that the procedures and/or computations performed using modules 110, 120, 130 may be implemented using fewer or more modules than illustrated. It should be understood that any of modules 110, 120, 130 may communicate with one or more components included in system 400, such as but not limited to database(s) 430, server 420, or device 410. In the example of FIG. 1, the threat alert system 100 includes a content module 110, a relationship module 120, and an alert module 130.

The content module 110 may be a hardware-implemented module that may be configured to search, and review content available on social network applications, and retrieve content of interest in some embodiments. The content module 110 may be configured to perform constrained searches of social media content to identify security and safety threats among a user's content while ignoring, overlooking or discounting the user's benign lifestory.

The relationship module 120 may be a hardware-implemented module that may be configured to determine an existence of a relationship between a social network application user and an enterprise from the content available on social network applications, and store the existence of a relationship in a database. In an example embodiment, the relationship module 120 can determine an existence of a relationship between a social network application user and an enterprise from the content identified by the content module 110.

The alert module 130, which may be a hardware-implemented module or a software-implemented module, is configured to generate and transmit an alert to the associated enterprise identifying the content that includes safety and security concerns so that the enterprise may mitigate the concerns. The alert may be transmitted as an email message, a SMS message, or other communication means. In some embodiments, the alert may be incorporated into a report including multiple alerts for the enterprise. In some embodiments, the alert and/or the report may include the content of concern and information on the author of the content.

The library terms database 140, as described in detail below, may be configured to store a list of terms that includes phrases, referred to as the library terms. One or more terms from the library terms are combined with the search terms by the content module 110 to perform constrained searches of social media content. In some embodiments, the library terms are organized by topic, and each topic may include or be associated with one or more algorithms for combining the library terms and/or phrases with the search terms to perform a constrained search of social media content.

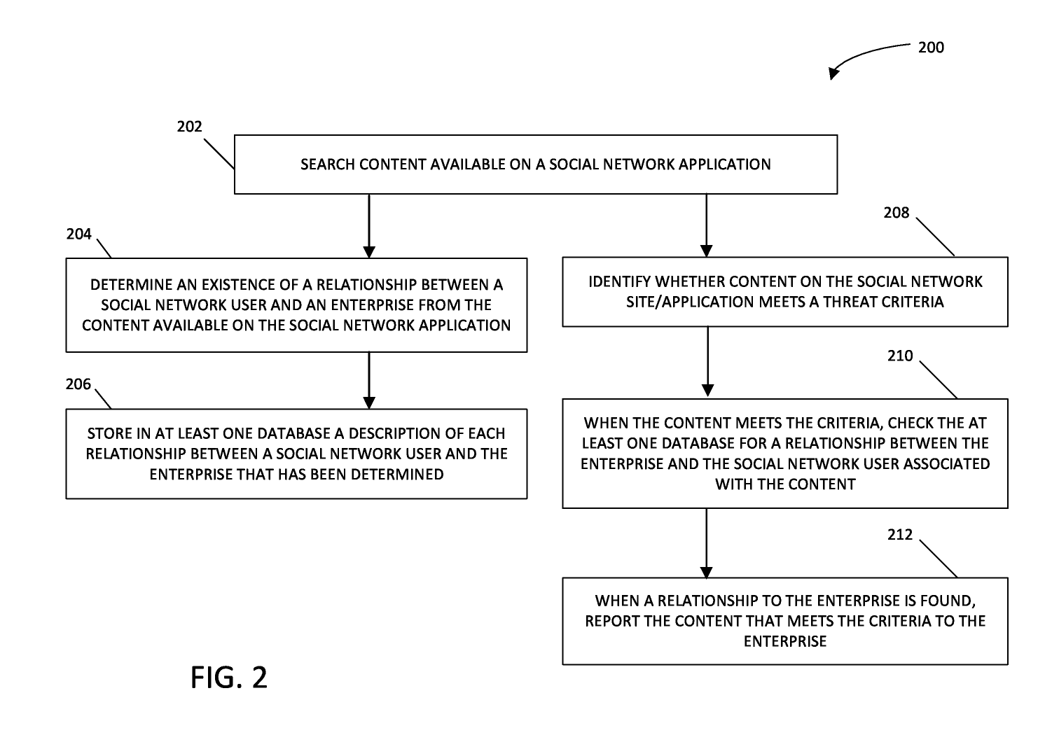

FIG. 2 is a flowchart showing an example method 200 for identifying relationships from social network content to mitigate enterprise safety and security concerns, according to an example embodiment. The method 200 may be performed using the example threat alert system 100 shown in FIG. 1.

In step 202, the content module 110 searches content available on a social network application. In some embodiments, the content module 110 can search content on multiple social network applications, such as Facebook, Flickr, Google+, Instagram, Meetup, Tumblr, Twitter, Vimeo, YouTube, WordPress, 4chan, Whisper, forums, and others. The content module 110 may assess publicly available content on social network applications including posts, photos, videos, comments, location information, user profile information, and other content. The assessment in step 202 may be continuous or periodic.

In step 204, the relationship module 120 determines an existence of a relationship between a social network application user and an enterprise from the content available on the social network application. In some embodiments, the existence of the relationship is determined from location information or metadata associated with the content, use of a name of an enterprise by the social network application user, use of a name of a person by the social network application user where the person is associated with an enterprise, the social network application user's connection with a person associated with an enterprise, or a combination of any of the aforementioned. The relationship module 120 may process content from the content module 110 to determine the existence of relationships. This processing of content from the content module 110 by the relationship module 120 may be performed continuously or in batches.

In some embodiments, the existence of a relationship is determined from the location information when the content indicates a geographic location of the social network application user as being near or at the enterprise while generating the content or making the content available to the social network application. Some social network applications allow a user to attach a location to the content based on where the user (or user's device) is physically located when the content is made available on the social network application. Some social network applications automatically attach location information to the content based on where the user (or user's device) is physically located when the content is made available on the social network application. Such information that identifies the physical location of the user when he or she made content available to the social network application is referred to here as location information. When the location information indicates that the user was in proximity of an enterprise, the relationship module 120 determines an existence of a relationship between the user and the enterprise based on the user's proximity to the enterprise when the user made content available in the social network application. Determining the user's proximity to an enterprise may be a configurable element in that a radius in miles or kilometers may be provided that when the user is within that radius, the user is considered in proximity to the enterprise.

Some social network applications allow a user to “check-in” at a location or enterprise. A user may or may not make additional content available while they are checked-in at a location or enterprise. Such check-in information is also referred to here as location information, and the relationship module 120 can determine an existence of a relationship between the user and the enterprise based on the user checking-in at the enterprise or the location of an enterprise.

In some embodiments, the existence of a relationship is determined from the location information or metadata when a user profile of the social network application user is associated with the content indicates a geographic location that is the location of the enterprise or a location near the enterprise. Some social network applications allow a user to maintain a user profile that contains information related to the user, such as demographic information, home address, work address, and the like. In some embodiments, the user profile may include information indicating that he or she lives or works near an enterprise. Such information is also referred to here as location information. The relationship module 120 can determine an existence of a relationship between the user and the enterprise based on the user's profile including location information.

In an example embodiment, the user may include the name of a location or an enterprise in the content that he or she makes available via the social network application. The relationship module 120 determines an existence of a relationship between the user and the enterprise mentioned in the content. In some embodiments, the user may include the name of a person associated with an enterprise in the content that he or she makes available via the social network application. The relationship module 120 determines an existence of a relationship between the user and the enterprise based on the content mentioning a person associated with the enterprise. A person associated with an enterprise, for example, may be an employee of the enterprise, a student of the enterprise, a client of the enterprise, or a fan of the enterprise. Similarly, a person associated with an enterprise, for example, may be a relative of a person associated with the enterprise or a person at or near the enterprise. In some embodiments, a list of persons who are associated with an enterprise may be provided in a database, and the relationship module 120 may query the database to determine whether the content mentions any of the persons on the list.

The relationship module 120 can also determine an existence of a relationship between the user and an enterprise based on the user's social network connection with a person associated with the enterprise. Some social network applications allow a user to “connect” with other users of the social network application. For example, the user associated with the content available on the social network application may have a social network connection in the social network application with a person associated with the enterprise. A person associated with an enterprise, for example, may be an employee of the enterprise. The relationship module 120 can use this information to determine an existence of a relationship between the user and the enterprise.

In an example embodiment, at step 202, the content module 110 assesses content recently made-available in the social network application, and at step 204, the relationship module 120 determines relationships from recently made-available content. In other embodiments, the content module 110 assesses old content or content made-available in the past in the social network application, and the relationship module 120 determines an existence of a relationship from prior interactions of the user with the social network application. For example, the content generated by the user in the past may include location information as described above. As another example, the user may have checked-in at an enterprise in the past, or the user may have mentioned the enterprise or a person associated with the enterprise in content made available by the user in the past.

In step 206, the relationship module 120 stores in at least one database the existence of each relationship between an author and the enterprise that has been determined. The relationship module 120 may determine an existence of a relationship between multiple social network application users (authors) and an enterprise. The relationship module 120 stores the information relating an author to an enterprise based on content or profile information made available by the author on social network applications as described above with relation to operation 204.

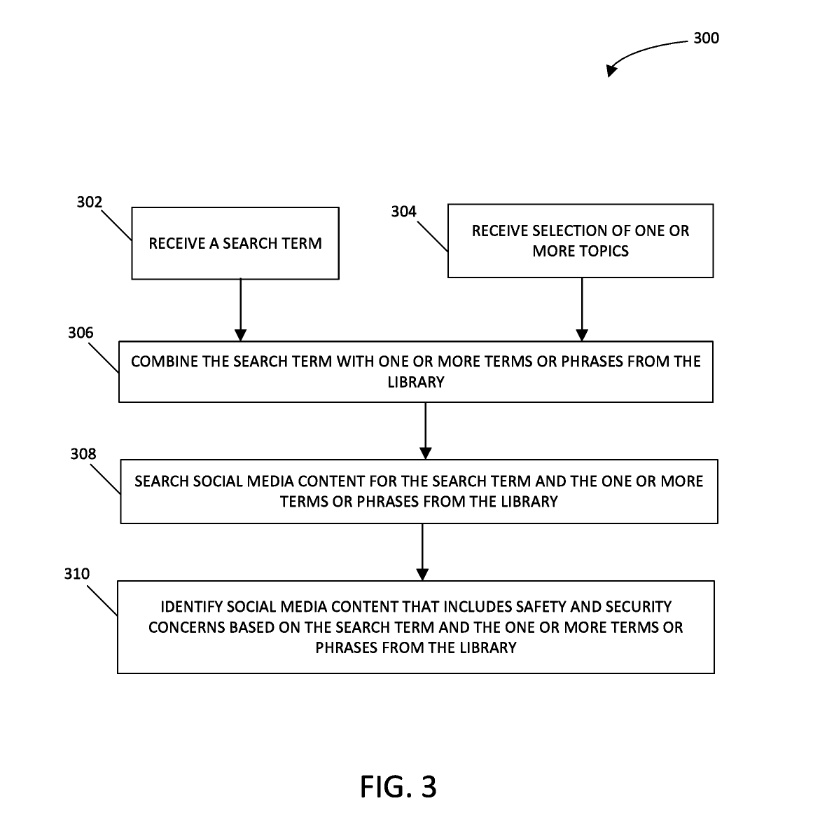

In step 208, which may be carried out concurrently with step 204 or at nearly the same time as step 204, the content module 110 identifies whether content available on the social network application meets a threat criteria. The content module 110 processes social media content and determines whether it meets a threat criteria continuously or in batches. The criteria may be a safety and security criteria that, when met, indicates the content includes a threat or relates to a safety and security concern. Any indication of the potential for harm, self-harm, and/or criminal activity that can endanger a person, a group of people, and/or property may satisfy a threat criteria. For example, the criteria may include the content using specific words or demonstrating certain intentions or emotions. A social network content reflecting behavior associated with self-harm, such as an expression of hopelessness, would meet a suicide threat criteria. A social network content reflecting templatized behaviors indicative or associated with mimetic (copycat) acts of violence, such as a well-known assault, would meet a harm threat criteria. Step 208 may be performed as described with respect to method 300 of FIG. 3. Step 208 may include steps 306, 308, and 310.

In step 210, when the content meets the criteria, the relationship module 120 queries the database for the existence of a relationship between the author of the content meeting the criteria and an enterprise as determined in step 204.

In some embodiments, the method 200 further includes assessing multiple social network applications and identifying a connection between an author on a first social network application and an author on a second social network application. An author on the first social network application may generate or make content available associated with an author on the second social network application in such a manner that it can be determined that the author on the first social network application and the author on the second social network application is the same. For example, the author may share content previously made available on the second social network application in the first social network application. As a non-limiting example, an author may share a Tweet™ from Twitter® in his or her account in Facebook®. The connection determined here may be stored in a database.

As described above, in an example embodiment, the existence of a relationship between an enterprise and an author of content made available on a social network application is determined and a description of the relationship is stored in a database. Content meeting a threat criteria is identified, and the database is queried to determine if a relationship exists between the author of the content meeting the criteria and an enterprise.

In another example embodiment, content available on a social network application is searched and content meeting a threat criteria is first identified. Then it is determined whether a relationship exists between an enterprise and the author of the content identified as meeting the criteria. The existence of a relationship can be determined by querying the database that may have stored a description of a relationship between an author and an enterprise. If the database does not indicate or support an existence of a relationship between the author and an enterprise, then existence of a relationship may be determined from the content identified as meeting the criteria (e.g., using various methods described in relation to step 204), or from past content made available by the author on the social network application (e.g., using various methods described in relation to step 204).

In some embodiments, in step 212, once an existence of a relationship is determined between an author of content that meets the criteria and an enterprise, the content meeting the criteria is provided to the enterprise. In step 212, when a relationship to the enterprise is found, the description of the relationship between the enterprise and the author of the content that meets the criteria may also be provided to the enterprise. With the information from step 212, the enterprise may take appropriate actions to prevent or avoid harm to the enterprise or persons associated with the enterprise.

To the extent that content that meets a threat criteria has been identified, but the database reports no relationship between the enterprise and the author of the content, another process may be initiated to look for a possible relationship. For example, the author's content available on various social networking applications may be reviewed. Accordingly, step 204 may follow step 210.

In this manner, the example systems and methods described herein identify relationships between the author of content on a social network application and an enterprise. Sometimes the relationship can be identified from the content itself because it mentions the name of the enterprise. Other times information related to the content and past behavior of the author is relied on to determine a relationship with an enterprise. Once a relationship is identified, the enterprise can be notified of the content of concern and of the user of concern so that safety and security concerns may be mitigated.

In an exemplary embodiment, the threat alert system employs a process that includes receiving one or more search terms that identify or describe assets or enterprises of interest, analyzing social media content against terms and phrases provided in a library to identify content that includes security and safety concerns, identifying a relationship between the content including safety and security concerns and an enterprise, and generating and transmitting an alert to the enterprise associated with the content including safety and security concerns.

In an example embodiment, a user provides a list of pages or usernames of social network applications that are hosted by an enterprise. The threat alert system retrieves a list of authors/social media users who follow or like the pages or usernames of the enterprise. This list of authors are stored in the database as authors who have a relationship with the enterprise. Social media content generated by these authors that include safety and security concerns causes the threat alert system to generate and transmit an alert to the enterprise identified in the database.

In an example embodiment, the threat alert system searches and analyzes social media content in four compartments, such as bucket, local, local/global and global. The threat alert system searches social media content and populates the bucket compartment with content that includes an asset or enterprise specific term (e.g., name of an asset or enterprise), content that was published or posted within a specified geolocation (e.g., within proximity of an asset or enterprise), or content that includes metadata connecting the author to an asset or enterprise (e.g., the author's social media profile indicates he or she is associated with the asset or enterprise). The content populated in the bucket compartment is generally directly related to an asset or enterprise of interest. The threat alert system compares the content within the bucket compartment with the library terms and phrases to identify content that includes security and safety concerns.

The threat alert system populates the local compartment by requesting from the social media providers all posts by an individual who self-references on his or her profile as being from a certain location. The threat alert system compares the content within the local compartment with the library terms and phrases to identify content that includes security and safety concerns.

The threat alert system populates the local/global compartment with social media content that include a threat against an asset or enterprise. For example, content such as “There is a shooter at UVM” is stored under the local/global compartment, where the threat alert system realizes that UVM refers to University of Vermont. Searches for content with potential threats to populate the local/global compartment are implemented as rules, which are queries, conducted on the social media provider's server or servers. The threat alert system compares the content including potential threats within the local/global compartment with the library terms and phrases to identify content that includes security and safety concerns.

The threat alert system populates the global compartment with social media content that include a threat against a generic asset or enterprise. For example, content such as “I'm going to shoot up the school today,” is stored under the global compartment. Searches for content with potential threats to populate the global compartment are implemented as rules, which are queries, conducted on the social media provider's server or servers. The threat alert system compares the content including potential threats within the global compartment with the library terms and phrases to identify content that includes security and safety concerns. Content stored under the global compartment is also analyzed to identify a relationship between the content author and an enterprise or asset.

FIG. 3 is a flowchart showing an example method 300 performed by the threat alert system for identifying safety and security concerns from social media content. The steps of method 300 may be performed using the example threat alert system 100 shown in FIG. 1.

The method 300 begins with step 302 and step 304. Step 302 and step 304 may be performed simultaneously or in a sequential order before the method continues to step 306. At step 302, the content module 110 receives a search term. In some embodiments, the threat alert system runs a system-generated search and the content module 110 receives one or more search terms from a database. In an example embodiment, the search terms may be stored in the database by a user of the threat alert system to run periodic searches of social media content to identify safety and security concerns. In some embodiments, a user may provide words and/or phrases that describe an asset or enterprise of interest to the user, or the user may provide a list of persons associated with the enterprise. For example, in some embodiments, a web form may be used to receive information regarding an enterprise and/or persons or organizations associated with the enterprise. A database of search terms may be generated based on these words and/or phrases and list of persons associated with the enterprise. The database of search terms may be generated by natural language processing of the words, phrases, and list of persons provided by the user. The database of search terms may be stored as search terms for a particular user or enterprise.

In another example embodiment, the threat alert system runs a user-defined or user initiated search, and the search term is received by a processor of the device 410 via a user interface displayed on the device 410. The user can enter a keyword, a phrase, a hashtag, etc. to initiate a search of social media content for the entered keyword, phrase or hashtag.

The search term may include identification of or a definition of various assets or an enterprise of interest that the user of the threat alert system wishes to protect. For example, the user may define physical locations (such as schools, parks, government buildings, etc.), and/or persons of interest (such as principles, mayors, sheriffs, nicknames for certain persons, etc.). The user may provide local terms used in a community (such as local names for drugs, local gang names, etc.). Information related to the assets, enterprise and local terms is stored in a database and can be used to run system-generated searches of social media content to identify safety and security concerns. Alternatively, the asset information, enterprise information, and local terms information can be provided by the user as a user-initiated search. The threat alert system may initiate system-generated searches of social media at pre-defined times. The search term may include identification of or terms related to an event of interest or a type of event of interest. The search term may include event-based keywords, hashtags, and/or phrases. The event may be a one-time event for which continued searching may not be necessary, or a recurrent event for which ongoing security searching may be desirable.

At step 304, the content module 110 receives a selection of one or more topics from a library stored in a database (for example, database 430 of FIG. 4). In some embodiments, the user of the threat alert system selects one or more topics from the library that are relevant to his or her safety or security concern. The user may have previously selected one or more topics of interest from the library. The system may store information regarding the user's selection for one or more topics of interest and use the stored selection information in current and future searches.

In some embodiments embodiment, the threat alert system does not receive or require a selection of topics from the library. The threat alert system performs a constrained search of social media content based on all the topics in the library, and generates an alert for social media content including safety and security concerns under any of the topics in the library.

In some embodiments, a selection of one or more topics is received from a user at a later time, for example after step 310, and the threat alert system provides the user with alerts only for the selected topics.

The threat alert system includes a library of terms, including phrases, which is stored in a database. The terms in the library are grouped by topic (e.g., hate, harm to others, active shooters, crowd-sourced events, and others). Exemplary topics and terms are described in detail below. A topic may include one or more terms. A term may be included under multiple topics. Within a topic, there may be different lists of terms. In some embodiments, one or more algorithms are associated with each topic, and describe how to combine the terms under each topic with the received search term or terms. Based on the selected topic or topics, the threat alert system combines the terms under a selected topic with the search term, so that the search of social media content is constrained to safety and security concerns and does not include benign lifestory of social media users. The threat alert system combines each term or phrase under the selected topic with the received search term, and searches social media content for each combination.

Topics may include, for example, active shooters, bullying, crowd-sourced events, drugs, harm to others, hate, person in crisis, sex crimes, terrorism, and others. Under the active shooters topic, the stored library terms and phrases may be further categorized into sub-topics, such as fandom and individual. Under the bullying topic, the stored library terms and phrases may be further categorized into sub-topics, such as tormentor and victim. Under the crowd-sourced events topic, the stored library terms and phrases may be further categorized into sub-topics, such as at school, demonstration and riots, road safety, and weather. Under the drugs topic, the stored library terms and phrases may be further categorized into sub-topics, such as buy/sell and use. Under the harm to others topic, the stored library terms and phrases may be further categorized into sub-topics, such as anti-government, anti-police, fighting, gangs, and threats. Under the terrorism topic, the stored library terms and phrases may be further categorized into sub-topics, such as recruitment and threats.

At step 306, the content module 110 combines the search term(s) with one or more terms from the topics from the library stored in a database (for example, database 430 of FIG. 4). In an example embodiment, only the terms under the selected topics are combined with the search term(s) to perform a constrained search of social media content. In an alternative embodiment, the terms or phrases available in the library under each topic are combined with the search term(s) to perform a constrained search of the social media content across all topics. In this embodiment, only the results of the search that were obtained under the selected topic or topics are delivered in an alert to the user of the threat alert system. For example, a user may select topics for which he or she wishes to receive alerts, such as, active shooters, drugs and bullying. Although the threat alert system performs a constrained search of social media content by combining the search term(s) with the terms and phrases in the library across all the topics, the user of the threat alert system only receives alerts for security and safety concerns that fall under the topics of active shooters, drugs and bullying. Searching across all topics may be more computationally intensive for searches of interest to one particular user, in the event that multiple users are interested in potential threats regarding an enterprise or closely related enterprises in different topics, performing the searching across all topics enables results regarding the enterprise to be used and user-selected topic-specific results selected from the results for all topics to be delivered to multiple different users, thereby increasing the overall efficiency of the system in some embodiments.

In some embodiments, the library includes lists of nouns, verbs and/or phrases for at least some of the topics. Depending on the topic, the library may also include additional lists of topic-specific terms, for example the hate topic also includes ‘vulnerable’ terms which indicate terms used in threats directed to a person from a vulnerable population (see example involving the hate topic below).

Depending on the topic, the threat alert system uses one or more algorithms to combine the search term with the one or more terms/phrases from the library. One of the algorithms associated with a topic may be an exact phrase search, where the received search term is combined with an exact phrase, and the social media content is searched for the search term and the exact phrase (see harm to others example below). Another algorithm associated with a topic may be sentence structure search, where social media content is searched for a term indicating a member of a vulnerable population in relatively close proximity (for example within 3-4 words) to a verb on a list of relevant verbs or to a noun on a list of relevant nouns (see hate topic example below). Yet another example algorithm is keyword search, where the received search term is combined with another term from the library, and social media content is searched for the search term and the library term. In some embodiments, under the keyword search algorithm, the received search term and the library term are within close proximity to one another, for example, within 3 to 5 words, or within 4 words. If the search term and the library term are separated by 10 or more words, then it may not indicate a safety and security threat. A topic may be associated with more than one algorithm, and a particular algorithm may be associated with more than one topic.

In addition to the topics, and the lists of terms and phrases, the library can also include an exclusion list. The exclusion list includes terms that may be excluded when a specific term (a search term or a library term) is searched. For example, if the term “shoot” is searched, the threat alert system performs the search while excluding results with photo in close proximity to shoot (e.g., excluding “photo shoot”). In this example, the exclusion list includes the term “photo” as associated with the term “shoot,” and when “shoot” is received as a search term or as a term from the library to combine with the received search term, the threat alert system excludes “photo shoot” as indicated by the exclusion list. As another example, the exclusion list may include multiple terms associated with the term “delta.” For example, a user may want to search for “delta airlines.” A search term such as delta can trigger results that include Greek organization names consisting of delta. In this case, the exclusion list includes “delta sigma theta” and “delta delta delta” as associated with the term “delta.” When “delta airlines” is received as a search term, the threat alert system excludes “delta sigma theta” and “delta delta delta” from the search as indicated by the exclusion list.

At step 308, the content module 110 searches social media content for the search term(s) and the one or more terms or phrases from the library. In some embodiments, the threat alert system may search content on multiple social media applications, such as Facebook, Flickr, Google+, Instagram, Meetup, Tumblr, Twitter, Vimeo, YouTube, WordPress, 4chan, Whisper, forums, and comments.

At step 310, the content module 110 identifies social media content that includes safety and security concerns based on the search term and the one or more terms from the library. In a non-limiting example, a user may want to identify safety and security concerns related to an event such as “a nude bike ride” in Vermont. The user enters search terms (e.g., keywords related to the event), the threat alert system combines the search terms with terms from the library that indicate threatening language for an event, and the threat alert system searches social media content based on the search terms and the one or more library terms to identify safety and security concerns.

In some embodiments, the threat alert system generates an alert to the user of the threat alert system when social media content is identified as including safety and security concerns as described with respect to method 200 of FIG. 2, in particular, according to step 212.

In an example embodiment, the relationship module 120 identifies a relationship between the author of the social media content that indicates a safety and security concern and an enterprise, as described in relation to method 200 of FIG. 2.

In an example embodiment, the alert module 130 generates and transmits an alert to the enterprise identified as associated with the content including safety and security concerns.

As a non-limiting example, the following content is assessed and considered: “Don't go to school tomorrow, I'm going to blow it up.” The threat alert system described here determines an existence of a relationship between the enterprise, Ridgefield High School, and the author of the content based on the content available on a social network application. This relationship is stored in a database. In this example, the library terms may include don't go to school” or “blow it up” and the search term may be Ridgefield High school. Based on the identification that the content meets a threat criteria (method step 208 and method steps 306-310) and establishing a relationship between the author and the enterprise (method steps 210 and 212) the content is reported (e.g., an alert is sent).

As another non-limiting example, the following content is identified and considered: “I hate working at the hospital.” The threat alert system described here determines an existence of a relationship between the enterprise, Springfield General Hospital, and the author of the content based on the content in a social networking application mentioning the name of the enterprise. A description of this relationship is stored in a database, however, an alert for this content is not provided to Springfield General Hospital because the content relates to the author's benign lifestory and does not rise to a security or safety concern. For example, the threat alert system described herein does not identify this example social media content as a result of interest because combining one or more library terms with the search terms does not produce this content as a result of interest.

As another non-limiting example, the following content is identified and considered: “I'm going to kill John Smith.” John Smith may be on a list of persons associated with an enterprise, for example, Springfield General Hospital. The threat alert system described here determines an existence of a relationship between the enterprise, Springfield General Hospital and the author of the content based on the content mentioning the name of a person associated with an enterprise.

The system would detect this content as including a threat based on the combination of the library term “kill” with a search term, which in this case may be John Smith. Based on the detected threat and the established relationship between target and the enterprise, an alert would be sent (e.g, Springfield General Hospital would be provided the content and the description of the relationship of the content to Springfield General Hospital).

As another non-limiting example, the following content is identified and considered: “I love John Smith.” John Smith may be on a list of persons associated with an enterprise, for example, State University. The threat alert system described here determines an existence of a relationship between the enterprise, State University, and the author of the content based on the content mentioning the name of a person associated with an enterprise. This content would not match any of the library terms and so would not be identified as content that includes a safety or security concern. A description of this relationship is stored in a database, however, an alert for this content would not be provided to State University because the content relates to the author's benign lifestory.

As another non-limiting example, the following content is identified and considered: “I am taking a gun to school tomorrow.” In this example the library terms would be “gun” in proximity to “school” and the content would meet the threat criteria. According to the user profile of the author of the content, he goes to school at Community College. The threat alert system described here determines an existence of a relationship between the enterprise, Community College, and the author of the content based on his user profile indicating that he frequents the enterprise because he attends school there. A description of this relationship is stored in a database, and Community College would be provided an alert on this content and the relationship.

As another non-limiting example, the following content is identified and considered: “I hate this place.” This content has location information associated with it because the author made it available at a particular geographic location that was stored by the social network application. The geographic location is that of the Best Hotel and Resort. The threat alert system described here determines an existence of a relationship between the enterprise, Best Hotel and Resort, and the author of the content based on the location information associated with the content. A description of this relationship is stored in a database, however, an alert for this content would be provided to Best Hotel and Resort because the content does not match any terms in the library and would not be identified as social media content that includes safety and security concerns.

As another non-limiting example, the following content is identified and considered: “I am going to kill my boyfriend.” According to the author's social network connections, John Smith is the author's boyfriend. John Smith is on the list of persons associated with the enterprise, Townville Municipality. The threat alert system described here determines an existence of a relationship between the enterprise, Townville Municipality, and the author of the content based on the author's social network connection with a person associated with the enterprise. A description of this relationship is stored in a database. Based on the library term “going to kill” in proximity to a person, this content would be identified as including a safety and security concern and Townville Municipality may be provided an alert on this content and the description of its relationship to Townville Municipality.

The terms and phrases included in the library indicate language and behaviors that are predictive of bad outcomes (generally safety or security concerns of the wellness of an enterprise, user's assets or user's community). These predictive concerns are coded in the library. In some embodiments, the terms and phrases to be included in the library are selected by analyzing various safety and security situations that have occurred and data mining threatening language and words that may indicate safety and security concerns. In some embodiments, safety and security experts, such as law enforcement, mental health professionals, anti-terrorism task forces, etc., may be consulted to determine which terms are included in the library. Additionally, the library also includes terms that appeared in social media content generated by or associated with persons who were involved in initiating safety and security concerns in the past. The library may include templates organized by topics. In some embodiments, a template may include a collection of some or all of keywords, hashtags, phrases, etc. and natural-language-processing (NLP) protocol and algorithm which connects the terms in the library under a specific topic with the search term(s) entered or provided by the user. In this manner, the library includes terms that can aid in identifying threats, threatening language, safety and security concerns against another or the general public.

In some embodiments, the library terms may specify terms that are not searched for or should not be included in social media content results that indicate a safety or security concern. For example, if the term “shoot” is in the library of terms, searches incorporating the word “shoot” would be structured not to target results where “shoot” is near the word “photo” to avoid drawing in results solely directed to a photography shoot.

In an example embodiment, a social media provider may prohibit searching of certain terms. For example, social media provider ‘A’ may not allow searching for the term “bully” or “bullying.” In this case, the threat alert system is configured to not search for the term “bully” or “bullying” when searching social media content available via the social media provider ‘A.’

Various non-limiting examples are described now to illustrate the use of the threat alert system and the library of terms. In a non-limiting example, the user of the threat alert system may want to search for safety and security concerns that fall under the hate topic of the library. In this example, the user selected the hate topic and the threat alert system retrieved a search term from a database based on asset definition or information provided by the user. For example, the user may have provided a name of a school or a university campus name or location as definition of an asset of interest. This asset information is combined with terms under the hate topic as explained below to perform a constrained search of social media content.

In this example, terms include profanity and offensive terms for people in various vulnerable populations. The profanity is included because it is commonly employed in threats. The offensive terms for people in vulnerable populations are included because such offensive terms are employed in threats against members of the vulnerable populations. In this description, certain letters will be replaced with asterisks for some of the particularly profane or offensive terms; however, the full words without asterisks appear in the library and are employed in searches.

Under the hate topic, the threat alert system searches for threats in two forms. For example, one form is [some threatening verb] near [a person from a vulnerable population]. Another form is [some weapon] near [a person from a vulnerable population]. In an example embodiment, the hate topic includes three lists of terms: vulnerable, nouns, and verbs. The hate topic vulnerable list of terms includes, but is not limited to: fag, faggot, queer, gay, lesbian, lesbo, dike, ni**er, jew, kike, heeb, spade, school, church, synagogue, mosque, and other terms or slurs that may be used to describe the previous terms in an offensive manner. The hate topic verbs list of terms includes, but is not limited to: f*ck, kill, beat, beating, burn, die, rape, knife, shoot, shoots, bust, crack, cut, bomb, and may include other terms or slang used as threatening verbs. The hate topic nouns list of terms includes, but is not limited to: glock, colt, ak, fist, bomb, and other terms or slang used to describe weapons.

Continuing with the non-limiting example, the threat alert system searches social media content to identify content that includes a target and a threatening action, where the target term and the threatening action terms are fairly close to each other, for example approximately within 3 to 5 words of each other or within 4 words of each other. If the target and threatening word are separated by 10 or more words, then it may not be considered fairly close and may not indicate a safety and security threat. The target term is selected from the vulnerable list and the threatening action term is selected from the verbs list under the hate topic. Similarly, the threat alert system also searches social media content to identify content that includes a target from the vulnerable list and a noun from the nouns list under the hate topic.

In another non-limiting example, the library includes a topic called harm to others. Under the harm to others topic, the library includes phrases from real-world examples where a person or persons published social media content with threatening language and then were involved in initiating the safety or security concern indicated in the content. For example, the phrases under the harm to others topic may be selected based on school shootings that have occurred in the past. The harm to others topic may include phrases like, but is not limited to, “will be your bloody head,” “will I see it to the end,” “won't see them again after tomorrow morning,” “you all make me sick,” “you are sending your most hated place to hell,” “you have to sacrifice them,” “you need to die now,” “you need to die too for being white,” “you won't see me coming,” and other variations of these phrases. If the threat alert system identifies social media content that includes any of these phrases, then it generates an alert to the user of the threat alert system.

As described above, a user of the threat alert system can enter information related to or defining assets that he or she wishes to protect. The user of the threat alert system can also enter a search term of interest. To limit false positives in the results and to ensure that the threat alert system outputs results that are not about a social media user's benign lifestory, but rather about safety and security issues, the threat alert system combines and constrain searches of social media content with information from the library. Based on the entered search term or the asset information, the threat alert system selects terms from the library for combination. For example, a search term or asset information like “city hall” may be combined with “bomb” for searching social media content. A search term or asset information that relates to an event where a large number of people may attend, may be combined with one or more terms from the ‘crowd-sourced events’ topic of the library. Such event based search terms may also be combined with one or more terms from the hate topic.

The crowd-sourced events topic in the library may include terms like, but not limited to, cop, riot, swat, arrest, burn, burned, burning, burns, civil disobedience, and others. As a non-limiting example, a user of the threat alert system may be interested in thwarting safety and security concerns for an event like a nude bike ride in Burlington, Vt. The user may search for “nude bike ride,” and the threat alert system identifies social media content that includes the search term “nude bike ride” and that also includes one or more terms from the library under the crowd-sourced events topic or the hate topic. In an example embodiment, the algorithm associated with the crowd-sourced events topic combines the search term and the library terms under the crowd source topic, and searches for them in close proximity to one another, for example, within 3 to 4 words of each other. Thus, the threat alert system generates an alert if there is social media content stating “riot at a nude bike ride,” but does not generate an alert if there is social media content stating “look at all the wackos at the nude bike ride.” In this manner, the threat alert system prevents unconstrained searching of social media content, and rather enables searching of social media content focused on identifying safety and security concerns.

In some embodiments, the threat alert system described herein performs complex forms of searching social media content to identify content including safety and security concerns. For example, one non-limiting complex form includes searching content that includes or indicates bullying concerns. People in crisis have often have been bullied. It is important for an institution of education, for instance, to know if a student or person associated with the institution is being bullied. One or more key events may also predict bad outcomes. When a person who is being bullied validates or accepts what the bully or bullies say, he or she is much more likely to act either inwardly (harm oneself) or outwardly (harm others).

The threat alert system includes exemplary models for victims and tormentors based on past observed behavior of known victims and tormentors. The threat alert system maintains statistics and data on victims and tormentors that may help identify a security or safety concern. For example, the threat alert system may identify various social media content that directs a certain amount of negative energy towards a victim, and in response, the threat alert system generates and transmits an alert. The threat alert system may identify social media content where the victim validates or accepts the language used by the bully, and in response, the threat alert system generates and transmits another alert. The threat alert system accomplishes this task by identifying tormentor language within social media content, identifying a relationship between the tormentor and victim, and then identify the victim's response in social media content.

In some embodiments, the library includes a topic called bullying, and the bullying topic may include sub-topics called victim and tormentor. The sub-topic victim may include terms including phrases that relate to a person that receives negative energy. The sub-topic tormenter may include terms including phrases that relate to a person that projects negative energy towards another person. Using the library topic bullying, the threat alert system identifies social media content that relates to bullying, and identifies a victim and a tormentor from the social media content. The library topic of bullying aims to avoid identifying social media content that includes benign negative comments or words that do not rise to the level of bullying. In an example embodiment, the threat alert system searches for social media content that references another social media author and includes language such as, but not limited to, “just commit suicide,” “you are a failure,” “you are insignificant,” “you are not loveable,” “you are shameful,” “you are stupid,” “you are ugly,” “you are worthless,” other terms, or any combination of these terms. Such content is identified as including a bullying concern. The author of such content may be identified as the tormentor, and the person identified or referenced in the content may be identified as the victim.

In an example embodiment, the threat alert system records a combination of tormentors and victims in a database. For example, there may be multiple tormentors directing negative energy towards one victim, there may be one tormentor directing negative energy towards one victim multiple times, there may be one tormentor directing negative energy towards multiple victims, or there may be multiple tormentors directing negative energy towards a set of victims.

Once content including bullying concerns is identified, the threat alert system identifies a relationship between the victim and an enterprise, and generates an alert and transmits it to the associated enterprise. In some embodiments, if a relationship between the victim and an enterprise cannot be identified, then the threat alert system identifies a relationship between the tormentor and an enterprise. In an example embodiment, an alert is generated and transmitted when the instances of content including bullying concerns against a single victim exceeds a threshold or predefined number. In one example, the alert identifies the victim, but does not identify the tormentor(s), because the objective is mitigate a bad outcome with respect to the victim and not to prosecute the tormentors.

In an example embodiment, the threat alert system generates and transmits an alert social media content is identified where the victim validates the negative energy directed towards him or her, which indicates that the victim is likely in crisis. Such content may include language such as, but not limited to, “I am a failure,” “I am insignificant,” “I am ugly,” “I am not loveable,” “I want to die,” “I'm sorry,” “I apologize,” other terms or phrases, or any combination of these terms or phrases. Another non-limiting example of complex form of searching employed by the threat alert system is identifying the sale of illicit substance or objects by assessing social media content. The threat alert system identifies social media content that indicate an undisclosed item for sale or any item for sale, a price, and language indicating that the conversation may continue offline (via non-public means).

The threat alert system described herein is also more efficient than conventional searching systems. Conventional systems provide a user with a large number of social media content, (e.g., hundreds, if not thousands or tens of thousands of posts), and the user has to determine the value of each and determine if the content includes a valid safety or security concerns. The searching process employed by conventional systems is time intensive and is often performed manually by full-time personnel/an employee. In contrast, the threat alert system described herein distills the amount of social media content that is searched and identifies content that includes valid safety and security concerns. Instead of a user inspecting a large amount of social media content results each day to provide the user with alerts regarding potential safety and security threats, with the results being typically 20 or fewer alerts a day.

Additionally, conventional systems analyze all content related to an enterprise. In contrast, the threat alert system described herein only analyzes content that meet a certain criteria as defined by the library of terms and phrases that relate to security and safety concerns. As such, the threat alert system described herein is more efficient in terms of time and resources.

FIG. 4 illustrates a network diagram depicting a system 400 for implementing embodiments of the threat alert system described herein. The system 400 can include a network 405, a device 410, a server 420, and database(s) 430. Each of the device 410, server 420, and database(s) 430 is in communication with the network 405.

In an example embodiment, one or more portions of network 405 may be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, any other type of network, or a combination of two or more such networks.

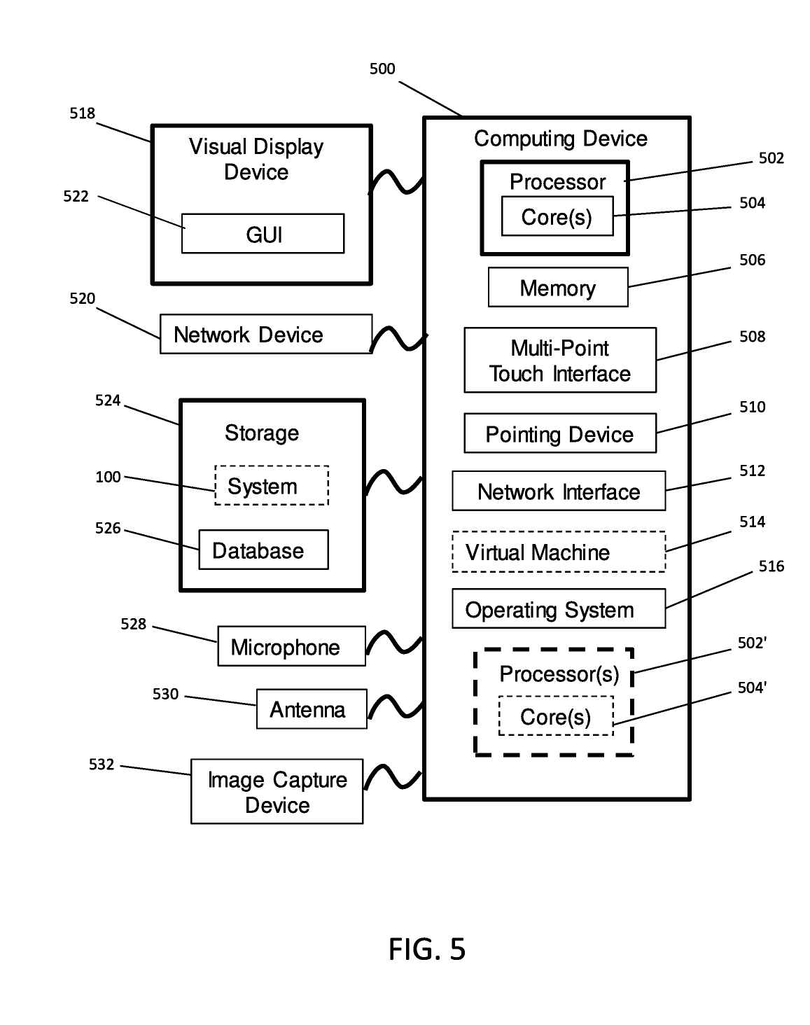

The device 410 may comprise, but is not limited to, work stations, computers, general purpose computers, Internet appliances, hand-held devices, wireless devices, portable devices, wearable computers, cellular or mobile phones, portable digital assistants (PDAs), smartphones, tablets, ultrabooks, netbooks, laptops, desktops, multi-processor systems, microprocessor-based or programmable consumer electronics, network PCs, mini-computers, and the like. The device 410 may include one or more components described in relation to FIG. 5.

The device 410 may connect to network 405 via a wired or wireless connection. The device 410 may include one or more applications or systems such as, but not limited to, a social media application, the threat alert system described herein (for example, system 100), and the like. In an example embodiment, the device 410 may perform all the functionalities described herein.

In other embodiments, the threat alert system 100 may be included on device 410, and the server 420 performs the functionalities described herein. In yet another embodiment, the device 410 may perform some of the functionalities of the threat alert system 100, and server 420 performs the other functionalities described herein. For example, device 410 may receive the search term from a user, while server 420 may combine the search with one or more terms from the library and search social media content to identify content that includes safety and security concerns.

The database(s) 430 may store the library terms 435 and asset information or search terms provided by the user. Each of the server 420 and database(s) 430 is connected to the network 405 via a wired connection. Alternatively, one or more of the server 420 and database(s) 430 may be connected to the network 405 via a wireless connection. Server 420 comprises one or more computers or processors configured to communicate with device 410 and/or database(s) 430 via network 405. Server 420 hosts one or more applications or websites accessed by device 410 and/or facilitates access to the content of database(s) 430. Server 420 also may include the threat alert system 100 described herein. Database(s) 430 comprise one or more storage devices for storing data and/or instructions (or code) for use by server 420 and/or device 410. Database(s) 430 and server 420 may be located at one or more geographically distributed locations from each other or from device 410. Alternatively, database(s) 430 may be included within server 420.

FIG. 5 is a block diagram of an exemplary computing device 500 that may be used to implement exemplary embodiments of the threat alert system described herein. The computing device 500 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives, one or more solid state disks), and the like. For example, memory 506 included in the computing device 500 may store computer-readable and computer-executable instructions or software for implementing exemplary embodiments of the threat alert system 100. The computing device 500 also includes configurable and/or programmable processor 502 and associated core(s) 504, and optionally, one or more additional configurable and/or programmable processor(s) 502′ and associated core(s) 504′ (for example, in the case of computer systems having multiple processors/cores), for executing computer-readable and computer-executable instructions or software stored in the memory 506 and other programs for controlling system hardware. Processor 502 and processor(s) 502′ may each be a single core processor or multiple core (504 and 504′) processor.

Virtualization may be employed in the computing device 500 so that infrastructure and resources in the computing device may be shared dynamically. A virtual machine 514 may be provided to handle a process running on multiple processors so that the process appears to be using only one computing resource rather than multiple computing resources. Multiple virtual machines may also be used with one processor.

Memory 506 may include a computer system memory or random access memory, such as DRAM, SRAM, EDO RAM, and the like. Memory 506 may include other types of memory as well, or combinations thereof.

A user may interact with the computing device 500 through a visual display device 518, such as a computer monitor, which may display one or more graphical user interfaces 522 that may be provided in accordance with exemplary embodiments. The computing device 500 may include other I/O devices for receiving input from a user, for example, a keyboard or any suitable multi-point touch interface 508, a pointing device 510 (e.g., a mouse), a microphone 528, and/or an image capturing device 532 (e.g., a camera or scanner). The multi-point touch interface 508 (e.g., keyboard, pin pad, scanner, touch-screen, etc.) and the pointing device 510 (e.g., mouse, stylus pen, etc.) may be coupled to the visual display device 518. The computing device 500 may include other suitable conventional I/O peripherals.

The computing device 500 may also include one or more storage devices 524, such as a hard-drive, CD-ROM, or other computer readable media, for storing data and computer-readable instructions and/or software that implement exemplary embodiments of the threat alert system described herein. Exemplary storage device 524 may also store one or more databases for storing any suitable information required to implement exemplary embodiments. For example, exemplary storage device 524 can store one or more databases 526 for storing information, such terms of the library of the threat alert system, and any other information to be used by embodiments of the threat alert system 100. The databases may be updated manually or automatically at any suitable time to add, delete, and/or update one or more data items in the databases.

The computing device 500 can include a network interface 512 configured to interface via one or more network devices 520 with one or more networks, for example, Local Area Network (LAN), Wide Area Network (WAN) or the Internet through a variety of connections including, but not limited to, standard telephone lines, LAN or WAN links (for example, 802.11, T1, T3, 56kb, X.25), broadband connections (for example, ISDN, Frame Relay, ATM), wireless connections, controller area network (CAN), or some combination of any or all of the above. In exemplary embodiments, the computing device 500 can include one or more antennas 530 to facilitate wireless communication (e.g., via the network interface) between the computing device 500 and a network. The network interface 512 may include a built-in network adapter, network interface card, PCMCIA network card, card bus network adapter, wireless network adapter, USB network adapter, modem or any other device suitable for interfacing the computing device 500 to any type of network capable of communication and performing the operations described herein. Moreover, the computing device 500 may be any computer system, such as a workstation, desktop computer, server, laptop, handheld computer, tablet computer (e.g., the iPad™ tablet computer), mobile computing or communication device (e.g., the iPhone™ communication device), or other form of computing or telecommunications device that is capable of communication and that has sufficient processor power and memory capacity to perform the operations described herein.

The computing device 500 may run any operating system 516, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, or any other operating system capable of running on the computing device and performing the operations described herein. In exemplary embodiments, the operating system 516 may be run in native mode or emulated mode. In an exemplary embodiment, the operating system 516 may be run on one or more cloud machine instances.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements, device components or method steps, those elements, components or steps may be replaced with a single element, component or step. Likewise, a single element, component or step may be replaced with a plurality of elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the invention. Further still, other embodiments, functions and advantages are also within the scope of the invention.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

What is claimed is:

1. A method for identifying safety and security concerns from social media content, the method comprising:
storing a library of terms in a database, the library of terms representing terms to constrain searching of social media content to safety and security concerns;
receiving one or more search terms;
combining the one or more search terms with one or more terms from the library stored in the database;
searching, using a processor, social media content based on the combination of the one or more search terms and the one or more terms from the library;
identifying social media content results that include safety and security concerns based on the combination of the one or more search terms and the one or more terms from the library;
determining an existence of a relationship between an author of the identified social media content results and an enterprise; and
generating and transmitting an alert to a device associated with the enterprise, the alert including at least the social media content results.

2. The method of claim 1, wherein searching social media content based on the combination of the one or more search terms and the one or more terms from the library includes searching based on a grammatical relationship between the one or more search terms and the one or more terms from the library in the social media content.

3. The method of claim 1, wherein combining the one or more search terms with the one or more terms in the library includes specifying an order for the one or more search terms relative to the one or more terms in the library in the social media content.

4. The method of claim 1, further comprising generating a database of search terms based, at least in part, on keywords received as user input via a user interface.

5. The method of claim 4, wherein the one or more search terms are retrieved from the database of search terms.

6. The method of claim 1, wherein the one or more search terms are received via a user interface from a user, and in response to receiving the one or more search terms from the user, initiating the search of the social media content based on the combination of the one or more search terms and the one or more terms from the library.

7. The method of claim 1, wherein the one or more search terms is stored in a database, and the social media content is searched periodically for the combination of the stored search terms and the one or more terms from the library.

8. The method of claim 1, wherein the library includes a list of nouns, verbs, and phrases.

9. The method of claim 1, wherein the terms in the library are organized into topics, and each topic includes an algorithm used to combine the one or more search terms with the one or more terms from the library under the respective topic.

10. The method of claim 5, further comprising receiving a selection of one or more topics from the library.

11. The method of claim 1, wherein the existence of a relationship between an author of the identified social media content results and the enterprise is determined by querying a database storing a pre-determined description of a relationship between an author and an enterprise.

12. The method of claim 1, wherein the existence of the relationship is determined from one or more of location information, the author's use of a name of the enterprise, the author's use of a name of a person associated with the enterprise, and the author's connection with a person associated with the enterprise.

13. The method of claim 1, wherein the one or more search terms relate to or describe an enterprise of interest.

14. The method of claim 1, further comprising generating a database identifying relationships between one or more victims and one or more tormentors based on analysis of the social media content results generated by the one or more tormentors.

15. The method of claim 14, further comprising generating the alert based on the social media content results including social media content generated by the one or more victims.

16. The method of claim 15, further comprising transmitting the alert to the enterprise identified as having a relationship with the one or more victims.

17. A system for identifying safety and security concerns from social media content, the system comprising:
a processor;
a memory in communication with the processor and storing instructions that cause the processor to:
store a library of terms in a database, the library of terms representing terms to constrain searching of social media content to safety and security concerns;
receive one or more search terms;
combine the one or more search terms with one or more terms from the library stored in the database;
search social media content based on the combination of the one or more search terms and the one or more terms from the library;
identify social media content results that include safety and security concerns based on the combination of the one or more search terms and the one or more terms from the library;
determine an existence of a relationship between an author of the identified social media content results and an enterprise; and
generate and transmit an alert to a device associated with the enterprise, the alert including at least the social media content results.

18. The system of claim 17, wherein the instructions to cause the processor to search social media content based on the combination of the one or more search terms and the one or more terms from the library include instructions to cause the processor to search based on a grammatical relationship between the one or more search terms and the one or more terms from the library in the social media content.

19. The system of claim 17, wherein the instructions to cause the processor to combine the one or more search terms with one or more terms from the library stored in the database include instructions to cause the processor to specify an order for the one or more search terms relative to the one or more terms in the library in the social media content

20. The system of claim 17, wherein the instructions further cause the processor to generate a database of search terms based on keywords received as user input via a user interface.

21. The system of claim 20, wherein the one or more search terms are retrieved from the database of search terms.

22. The system of claim 17, wherein the one or more search terms are received via a user interface from a user, and in response to receiving the one or more search terms from the user, the system initiates the search of the social media content for the one or more search terms and the one or more terms from the library.

23. The system of claim 17, wherein the one or more search terms are stored in the database, and the system searches the social media content periodically for the combination of the stored search terms and the one or more terms from the library.

24. The system of claim 17, wherein the library includes a list of nouns, verbs, and phrases.

25. The system of claim 17, wherein the terms in the library are organized into topics, and each topic includes an algorithm used to combine the one or more search terms with the one or more terms from the library under the respective topic.

26. The system of claim 25, wherein the instructions further cause the processor to receive a selection of one or more topics from the library.

27. The system of claim 17, wherein the existence of a relationship between an author of the identified social media content results and the enterprise is determined by querying a database storing a pre-determined description of a relationship between an author and an enterprise.

28. The system of claim 17, wherein the existence of the relationship is determined from one or more of location information, the author's use of a name of the enterprise, the author's use of a name of a person associated with the enterprise, and the author's connection with a person associated with the enterprise.

29. The system of claim 17, wherein the one or more search terms relate to or describe an enterprise of interest.

30. A non-transitory computer-readable storage medium storing code representing instructions that when executed are configured to cause a processor to perform a method comprising:
storing a library of terms in a database, the library of terms representing terms to constrain searching of social media content to safety and security concerns;
receiving one or more search terms;
combining the one or more search terms with one or more terms from the library stored in the database;
searching, using a processor, social media content based on the combination of the one or more search terms and the one or more terms from the library;
identifying social media content results that include safety and security concerns based on the search term and the one or more terms from the library;
determining an existence of a relationship between an author of the identified social media content results and an enterprise; and
generating and transmitting an alert to a device associated with the enterprise, the alert including at least the social media content results.

31. The non-transitory computer-readable storage medium of claim 30, wherein searching social media content based on the combination of the one or more search terms and the one or more terms from the library includes searching based on a grammatical relationship between the one or more search terms and the one or more terms from the library in the social media content.

32. The non-transitory computer-readable storage medium of claim 30, wherein combining the one or more search terms with the one or more terms in the library includes specifying an order for the one or more search terms relative to the one or more terms in the library in the social media content.

33. The non-transitory computer-readable storage medium of claim 30, wherein the library contains a list of nouns, verbs, and phrases.

34. The non-transitory computer-readable storage medium of claim 30, wherein the terms in the library are organized into topics, and each topic includes an algorithm used to combine the one or more search terms with the one or more terms from the library under the respective topic.

35. The non-transitory computer-readable storage medium of claim 30, wherein the existence of a relationship between an author of the identified social media content results and the enterprise is determined by querying a database storing a pre-determined description of a relationship between an author and an enterprise.

36. The non-transitory computer-readable storage medium of claim 30, wherein the existence of the relationship is determined from one of location information, the author's use of a name of the enterprise, the author's use of a name of a person associated with the enterprise, and the author's connection with a person associated with the enterprise.
